(19) United States
(12) Patent Application Publication
(10) Pub. No.: US 2007/0244863 A1
(43) Pub. Date: Oct. 18, 2007

(54) Systems and methods for performing searches within vertical domains

(76) Inventors: Randy Adams, Menlo Park, CA (US); Paul Pedersen, Palo Alto, CA (US)

Correspondence Address: JONES DAY, 222 EAST 41ST ST, NEW YORK, NY, 10017, US

(21) Appl. No.: 11/404,687

(22) Filed: Apr. 13, 2006

(51) Int. Cl. G06F 17/30

(52) U.S. Cl. 707/3

(57) ABSTRACT

A graphical user interface stored in a memory of a client computer is provided. The interface comprises a prompt field for a vertical search query from a user. The interface further comprises a field for displaying a plurality of names. Each such name represents a vertical collection. The plurality of names is automatically populated, at a time when the user is still entering characters in the prompt field, as a function of one or more character strings in the prompt field. A computer comprising a memory storing instructions for receiving a vertical search query, communicating the query to a remote computer, and receiving a plurality of names from the remote computer. Each name represents a vertical collection having relevance to the vertical search query. The plurality of names is displayed at a time when the user is still entering additional characters into the vertical search query.

### CROSS-REFERENCE TO RELATED APPLICATION

This application is related to concurrently filed U.S. patent application Ser. No. to be determined, Attorney Docket No. 11736-002-999, entitled “Systems and Methods for Ranking Vertical Domains,” filed Apr. 13, 2006, which is hereby incorporated by reference herein in its entirety.

### 1. FIELD OF THE INVENTION

The present invention relates generally to information search and retrieval. More specifically, systems and methods are disclosed for improving Internet searches using vertical domains.

### 2. BACKGROUND OF THE INVENTION

The web creates new challenges for information retrieval. The amount of information on the web is growing rapidly. With new and easier to use web tools, users with less or no formal web training are able to access websites. Many search engines, such as Google and Yahoo!, allow users to search and retrieve information. These conventional search engines are horizontal in nature. They index the entire web. Then, search queries provided by users are searched against this index and the most relevant results are returned. However, because of the vast quantity of information available on the Internet, as well as the complexity of such information, increasingly complex search expressions are needed to extract useful information from such horizontal indexes.

Moreover, because words often have more than one meaning, search terms often retrieve unintended categories of documents. For example, the word “tiger” can mean the carnivorous animals that are only found in parts of Asia. It is also the last name of golf legend Tiger Woods as well as the name of a Macintosh operating system. Thus, use of the term “tiger” as a search term in a conventional search engine is likely to retrieve a mishmash of documents including some having to do with animals, some having to do with golf, and some having to do with operating systems. The sponsored links and/or advertisements returned with such a search query will similarly be all over the map. To illustrate the problem, in response to the search query “tiger” recently entered into Google, the top responses included a link to the computer peripherals store TigerDirect.com, a link to the “Save the Tiger Fund,” a link to the Macintosh OS X tiger operating system, a link to “Tiger Haven” (a sanctuary for lions, tigers, and jaguars), a link to the Official Website for Tiger Woods, as well as an advertisement to search for “tigers” on eBay.com. Thus, because the same phrases have completely different meaning to different people, an ambiguity in search expressions is often unavoidable. This makes information search and retrieval more difficult and poses a significant problem to users. It is also problematic to web portals because of the inability to server focused advertisements that are truly relevant to search queries provided by users.

One way to address the ambiguities inherent in text based search expressions is to limit searches to databases that are themselves limited to particular subjects. Web search engines (e.g., dmoz, Yahoo!, looksmart, etc.) provide such subject specific databases. For example, dmoz has collected millions of sites which are then classified into thousands of categories. These categories are arranged in a hierarchical fashion. FIG. 1 illustrates top level categories (e.g., database 102) for dmoz. Each category is essentially a database of documents limited to one or more particular subjects. Searches may be restricted to any one of these specific directories. Although dmoz limits searches to specific categories, the hierarchical user interface is inconvenient. Substantial amounts of time and effort are often spent searching the hierarchical listings for exactly the right database. The user must often drill down as many as five or more levels before reaching the desired directory or web page. Search queries entered at the top level of dmoz return an array of database possibilities. However, the database possibilities include full hierarchical information for each database. While such hierarchical information conveys information to some users, to the average user, this hierarchical information is not helpful. Worse still, the hierarchical information complicates the task of identifying a suitable database of documents to search.

In contrast to dmoz, search engines such as looksmart and Yahoo! provide a flat non-hierarchical listing of categories of topics. However, the drawback with such approaches is that it presupposes that the user actually knows which category a particular search query should be directed towards. But the user often has no idea what category to search. Should one search for questions about gardens in the “food category” or the “home living” category? Should golf shoes be searched in “style”, “sports” or “clothing” ? Does the “finance” category cover mutual funds, given that there is a wholly separate “mutual funds” category? Thus, the drawback with portals such as looksmart and Excite! is that there is no effective way to communicate to the portal which category to search, prior to conducting that actual search.

Given the above background, what is needed in the art are improved systems and methods for searching for documents using the Internet or other wide area network.

### 3. SUMMARY OF THE INVENTION

The present invention provides vertical suggestions in response to user input. Typically this input is by way of a keyboard or other data entry device. A user enters letters and/or words on the data entry device, and the system converts these letters and/or words into one or more queries for candidate vertical collections. The system evaluates the candidate vertical collections and returns a list of names of relevant candidate vertical collections. The user may then continue the interaction by selecting one of the suggested candidate vertical collections. The system will then search the selected vertical collection and return a list of documents from that selected vertical collection that are relevant to the user input.

One aspect of the invention provides a graphical user interface stored in a memory of a client computer. The graphical user interface comprises a prompt field for obtaining a vertical search query from a user as well as a display field for displaying a plurality of names. Each name in the plurality of names represents a vertical collection in a plurality of vertical collections. The plurality of names in the display field is automatically populated, at a time when the user is still entering additional characters in the prompt field, as a function of one or more terms entered by the user in the prompt field.

In some embodiments, each respective name in the plurality of names in the display field is displayed as a graphic having a size that is a function of a vertical search query based relevance of the vertical collection represented by the respective name. For example, in some embodiments, a first graphic in the display field has a larger size than a second graphic in the display field when the first graphic represents a first vertical collection in the plurality of vertical collections that is more relevant to the vertical search query than a second vertical collection in the plurality of vertical collections that is represented by the second graphic.

In some embodiments, each name in the plurality of names in the display field is displayed as a graphic having a visual indicia. The visual indicia of a respective graphic displayed in the display field is determined by a relevance of the vertical collection that is represented by the respective graphic. In some embodiments, this visual indicia is size or color.

In some embodiments, each vertical collection in the plurality of vertical collections is located on a remote server and comprises documents that relate to a particular category. In some cases, the graphical user interface is run as an application within a network accessible browser. In some embodiments, the plurality of names in the display field is re-populated each time one or more characters is entered by the user in the prompt field by communicating the contents of the prompt field to a remote server after the one or more characters is entered by the user. In such embodiments a new plurality of names is received from the remote server to display in the display field as a function of the contents of the prompt field communicated to the remote server. In some embodiments, the contents of the prompt field are sent to a remote server after each character is typed into the prompt field by a user. In some embodiments, the contents of the prompt field are sent to a remote server when an end of string signal is detected. In some embodiments, the vertical search query comprises a single character. In some embodiments, the vertical search query comprises a plurality of terms separated from each other by one or more predicate conditions (e.g., AND, OR, NOT).

Yet another aspect of the present invention provides a computer program product for use in conjunction with a client computer system. The computer program product comprises a computer readable storage medium and a computer program mechanism embedded therein. The computer program mechanism comprises instructions for receiving a vertical search query from a user of the client computer system, instructions for communicating the vertical search query to a remote computer, and instructions for receiving a plurality of names from the remote computer. Each name in the plurality of names represents a vertical collection in a plurality of vertical collections. Each vertical collection in the plurality of vertical collections has a relevance to the vertical search query. The computer program product further comprises instructions for displaying the plurality of names at a time when the user is still entering additional characters into the vertical search query.

In some embodiments, each respective name in the plurality of names is displayed as a graphic having a size that is a function of a relevance of the vertical collection represented by the respective name. In one example, a first graphic that is displayed has a larger size than a second graphic when the first graphic represents a first vertical collection in the plurality of vertical collections that is more relevant to the vertical search query than a second vertical collection that is represented by the second graphic. In some embodiments, each name in the plurality of names is displayed as a graphic having a visual indicia and the visual indicia of a respective graphic is determined by a vertical search query based relevance of the vertical collection represented by the respective graphic. In some embodiments, the visual indicia is size or color.

Still another embodiment of the present invention provides a computer comprising a central processing unit and a memory coupled to the central processing unit. The memory stores instructions for receiving a vertical search query from a user of the computer, instructions for communicating the vertical search query to a remote computer, and instructions for receiving a plurality of names from the remote computer. Each name in the plurality of names represents a vertical collection in a plurality of vertical collections. Each vertical collection has a relevance to the vertical search query. The memory further stores instructions for displaying the plurality of names at a time when the user is still entering additional characters into the vertical search query.

Yet another embodiment of the present invention comprises a digital signal embodied on a carrier wave comprising a plurality of names. Each name in the plurality of names represents a vertical collection in a plurality of vertical collections. Each vertical collection in the plurality of vertical collections has a relevance to a vertical search query. The digital signal embodied on a carrier wave further comprises a plurality of scores. Each score in the plurality of scores corresponds to a name in the plurality of names. Each score represents a relevance of a vertical collection in the plurality of vertical collections to the vertical search query. In some embodiments, the vertical search query comprises a single character. In some embodiments, the vertical search query comprises a plurality of terms, where terms in the plurality of terms are optionally separated from each other by one or more predicate conditions.

### 4. BRIEF DESCRIPTION OF THE DRAWINGS

FIG. 1 illustrates the dmoz web site portal in accordance with the prior art.

FIG. 2 illustrates a client computer submitting a query to a vertical engine server in accordance with an embodiment of the present invention.

FIGS. 3A-3F illustrate a progressive search of vertical categories relevant to the vertical search query “tiger” as each character of the vertical search query is entered into a prompt in accordance with an embodiment of the present invention.

FIG. 4 illustrates a vertical engine server 400 in accordance with one embodiment of the present invention.

FIG. 5 illustrates the architecture of a vertical index in accordance with one embodiment of the present invention.

FIG. 6 illustrates an exemplary method in accordance with an embodiment of the present invention.

Like reference numerals refer to corresponding parts throughout the several views of the drawings.

### 5. DETAILED DESCRIPTION

The present invention differs from known search engines. In the present invention, vertical collections are used rather than using an index that represents the entire Internet. A “vertical collection” comprises a set of documents (e.g., URLs, websites, etc.) that relate to a common category. For example, web pages pertaining to sailboats could constitute a “sailboat” vertical collection. Web pages pertaining to car racing could constitute a “car racing” collection. Users search a vertical collection so that only documents relevant to the category represented by the vertical collection are returned to the user. Advantageously, the present invention provides systems and methods for helping a searcher identify the right vertical collection to search.

As shown in FIG. 2, a vertical search query is submitted by a client computer 100 to a vertical engine server 110. Upon receiving the vertical search query, vertical engine server 110 identifies vertical collections in a vertical collection index 442 that are relevant to the search query. The names of the candidate vertical collections are then returned to client computer 100. The user then selects one of the vertical collections and proceeds to search the vertical collection with the original search expression or new search expressions.

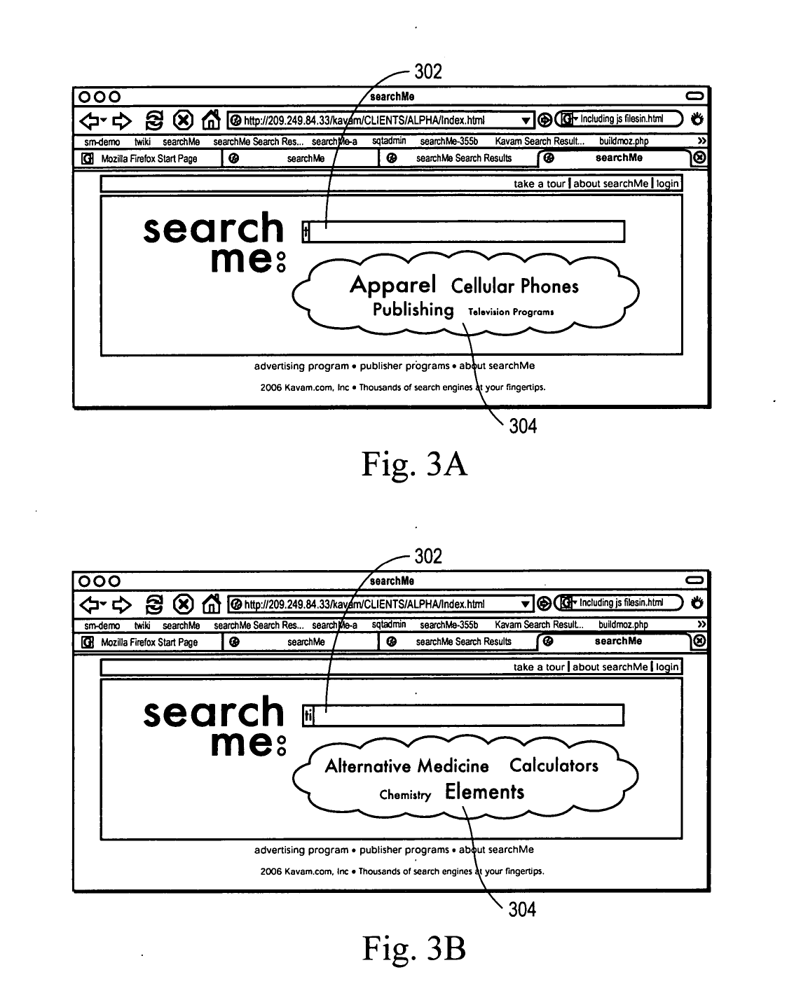

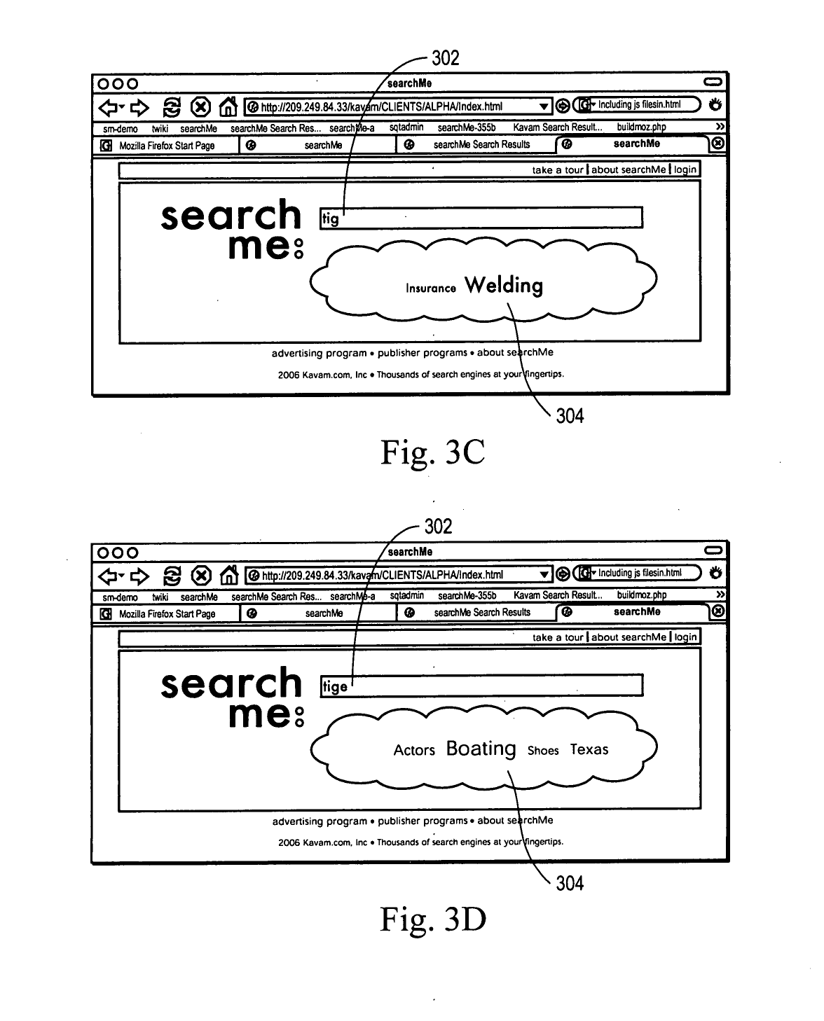

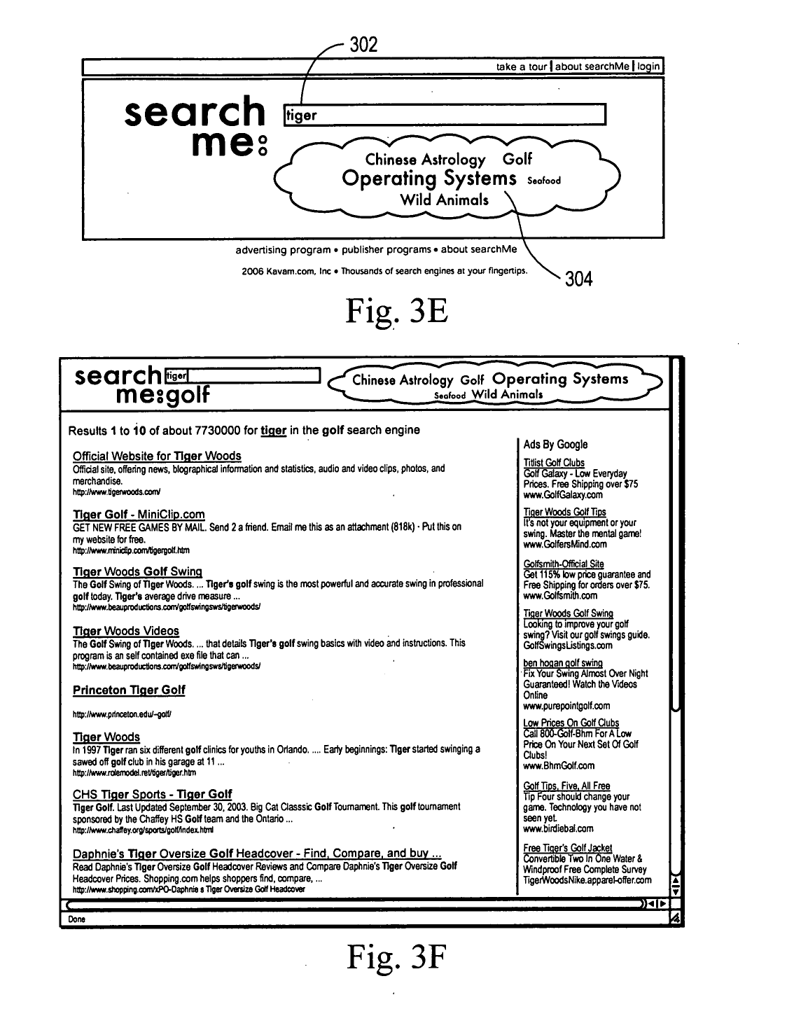

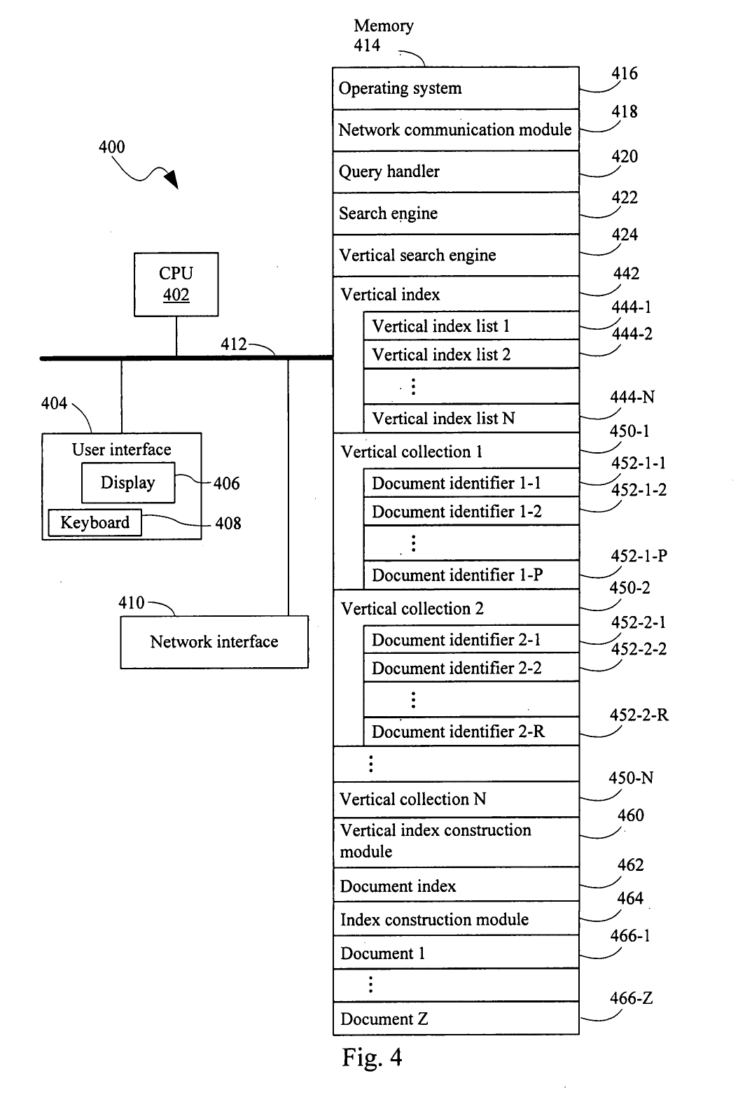

Before turning to details on how vertical engine server 110 generates the list of candidate vertical collections for a given search query, screen shots of candidate vertical collections returned by an embodiment of vertical engine server 110 are provided as FIGS. 3A-3F so that the advantages of the present invention can be better understood. In FIG. 3A, a user is provided with a graphic that includes a prompt 302. Notably, in FIG. 3A, while prompt 302 is present, there is no “search” toggle. Also present in FIG. 3A is v-cloud 304 displaying a collection of suggested vertical collections. The identity of the vertical collections listed in v-cloud 304 is wholly a function of the contents of prompt 302. In fact, in some embodiments of the present invention, the contents of prompt 302 are polled such that any time an additional keystroke, or in some instances a plurality of keystrokes, is entered into prompt 302, the contents of prompt 302 is treated as a vertical search query for which a new set of vertical collections is retrieved using vertical engine server 110. Then, v-cloud 304 is repopulated with the new set of vertical collections. In this way, v-cloud 304 always contains the most relevant vertical categories as the user adds additional characters into prompt 302. When the user selects one of the vertical collections in v-cloud 304, the corresponding vertical collection is searched using the vertical search query at prompt 302.

To illustrate the concepts of the invention, consider the search expression “tiger.” As illustrated in FIG. 3A, a user begins to build this search expression using prompt 302 by first entering the letter “t.” Before the user enters the character “i” at prompt 302, vertical engine server 110 searches vertical collection index 120 for the vertical collections most relevant to the vertical search query “t”. Vertical engine server 110 then communicates the identity of these most relevant vertical collections to client computer 100 where they are used to populate v-cloud 304. Thus, responsive to the vertical search query “t” in prompt 302, v-cloud 304 includes the vertical collection “apparel” because “t” is prominent in the expression t-shirt, the vertical collection “cellular phone” because “t” is prominent in name of the cell phone company T-Mobile, the vertical collection “television programs” because “t” forms part of the expression “t.v.”, etc.

Referring to FIG. 3B, when the user types an “i” within prompt 302, vertical engine server 110 searches vertical collection index 120 for the vertical collections most relevant to the vertical search query “ti”. Vertical engine server 110 then communicates the identity of these most relevant vertical collections to client computer 100 where they are used to repopulate v-cloud 304. Thus, referring to FIG. 3B, responsive to the vertical search query “ti” at prompt 302, v-cloud 304 includes the vertical collection “calculators” because “ti” stands for the calculator manufacture Texas Instruments as well as the vertical collections “chemistry” and “elements” because “ti” is the chemical symbol of the element titanium. Referring to FIG. 3C, when the user types an “g” within prompt 302, vertical engine server 110 searches vertical collection index 120 for the vertical collections most relevant to the vertical search query “tig”. Vertical engine server 110 then communicates the identity of these most relevant vertical collections to client computer 100 where they are used to repopulate v-cloud 304. Thus, referring to FIG. 3C, responsive to the vertical search query “tig” at prompt 302, v-cloud 304 includes the vertical collection “insurance” because “tig” stands for the TIG insurance company. V-cloud 304 also includes the vertical collection “welding” because of the similarity between the vertical search query “tig” and a common form of welding known as tungsten inert gas (TIG) welding.

Referring to FIG. 3D, when the user types an “e” at prompt 302, vertical engine server 110 searches vertical collection index 120 for the vertical collections most relevant to the vertical search query “tige”. Vertical engine server 110 then communicates the identity of these most relevant vertical collections to client computer 100 where they are used to repopulate v-cloud 304. Thus, referring to FIG. 3D, responsive to the vertical search query “tige” at prompt 302, v-cloud 304 includes the vertical collection “actors” because of the similaractor Tige Andrews, the vertical collection “boating” because of the Tigé boat manufacturer, the vertical collection “shoes” because of the bull dog character used in Buster Brown comic strips associated with the Brown Shoe Company, as well as the vertical collection “Texas” because Tige canyon creak is located in Texas.

Referring to FIG. 3E, when the user completes the expression “tiger” by typing an “r” within prompt 302, vertical engine server 110 searches vertical collection index 120 for the vertical collections most relevant to the vertical search query “tiger”. Vertical engine server 110 then communicates the identity of these most relevant vertical collections to client computer 100 where they are used to repopulate v-cloud 304. Thus, referring to FIG. 3E, responsive to the vertical search query “tiger” at prompt 302, v-cloud 304 includes the vertical collection “Chinese astrology” because of the tiger birth sign in Chinese astrology, the vertical collection “golf” because of the famous golfer, Tiger Woods, the vertical collection “Operating Systems” because of the Tiger Macintosh operating system, the vertical collection “seafood”, because tiger shrimp is a form of seafood, and the vertical collection “wild animals” because a tiger, of course, is also a wild animal.

Thus, continuing to refer to FIG. 3E, consider the case in which a user is interested in Tiger Woods. Accordingly, the user selected the vertical category “golf” from v-cloud 304. Responsive to this selection, a search of the golf vertical collection is performed and the results are returned for display as illustrated in FIG. 3F. As can be seen, unlike the case of horizontal search engines such as Google, responsive to the Tiger vertical search query within the golf vertical collection, each of the documents returned relates to golf. This is beneficial from a user standpoint. The user never had to expend significant effort to identify a suitable category to search. With each keystroke, v-cloud 304 automatically provides several different candidate vertical collections to search. All the user has to do is to keep typing, character by character, until a relevant vertical category appears in v-cloud 304. Another advantage of the present invention, illustrated in FIG. 3F, is that each of the advertisements provided by vertical search engine 110 pertain to golf once the user has selected the golf vertical collection. Thus, the user is far more likely to respond to the advertisements.

An overview of the systems and methods of the present invention has been disclosed. From this overview, the many advantages and features of the present invention are apparent. The present invention automatically provides a user with a list of candidate vertical collections that can be used as the target of a user directed query. By using the systems and methods of the present invention, a user can search a target vertical collection for documents related to a search query with a minimal amount of effort needed to select the target vertical collection from among a list of candidate vertical collections. Thus, using the present invention, there is no longer a need to navigate through hierarchical lists of categories or to sift through search results obtained from a broad search of the entire Internet for documents related to a given search query.

Now that an overview of the invention and advantages of the present invention have been presented, a more detailed description of the systems and methods of the present invention will be disclosed. To this end, FIG. 4 illustrates a vertical engine server 110 in accordance with one embodiment of the present invention. In some embodiments, vertical engine server 110 is implemented using one or more computer systems 400, as schematically shown in FIG. 4. It will be appreciated by those of skill in the art, that vertical engines designed to process large volumes of vertical search queries may use more complicated computer architectures than the one shown in FIG. 4. For instance, a front end set of servers may be used to receive and distribute vertical search queries among a set of back-end servers that actually process the user queries. In such a system, system 400 as shown in FIG. 4 would be one such back-end server.

Computer system 400, will typically have a user interface 404 (including a display 406 and a keyboard 408), one or more processing units (CPU's) 402, a network or other communications interface 410, memory 414, and one or more communication busses 412 for interconnecting these components. Memory 414 can include high speed random access memory and can also include non-volatile memory, such as one or more magnetic disk storage devices (not shown). Memory 414 can include mass storage that is remotely located from the central processing unit(s) 402. Memory 414 preferably stores:

an operating system 416 that includes procedures for handling various basic system services and for performing hardware dependent tasks;

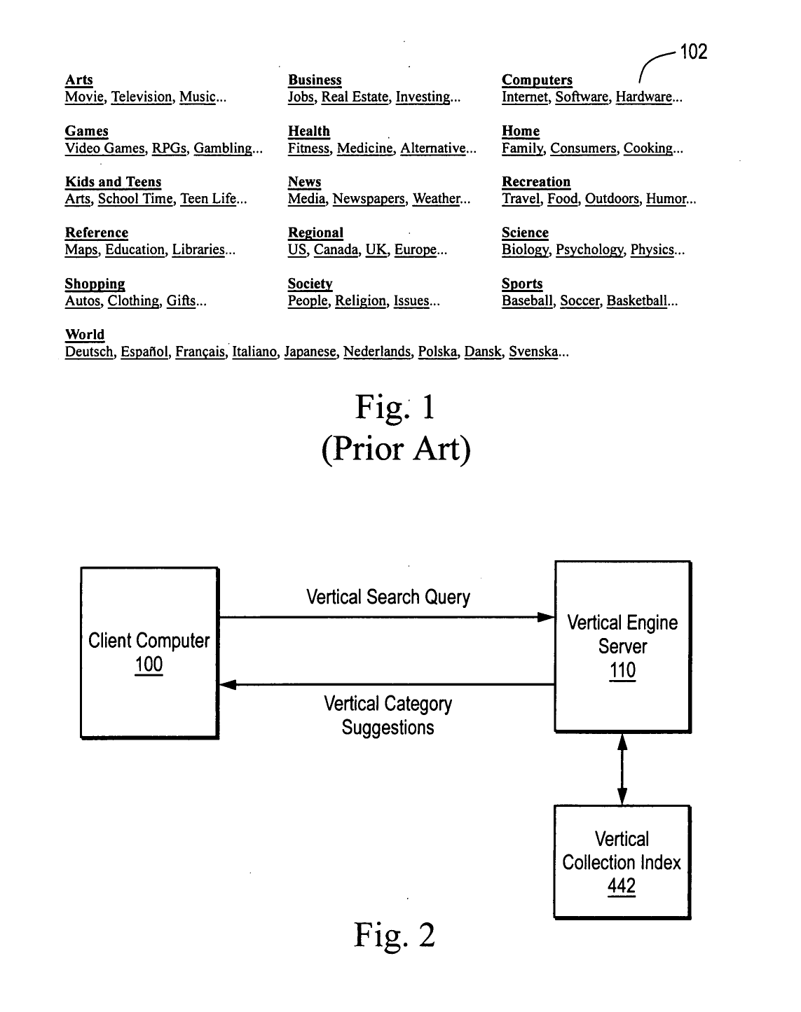

a network communication module 418 that is used for connecting system 400 to various client computers 100 (FIG. 1) and possibly to other servers or computers via one or more communication networks, such as, the Internet, other wide area networks, local area networks (e.g., a local wireless network can connect the client computers 100 to computer 400), metropolitan area networks, and so on;

a query handler 420 for receiving a vertical search query from a client computer 100;

a search engine 422 for searching a selected vertical collection 450 for documents 466 related to a vertical search query and for forming a group of ranked documents that are related to the search query;

a vertical search engine 424, for searching vertical index 442 for one or more vertical index lists 444 that are relevant to a given vertical search query;

a vertical index construction module 460 for constructing vertical index 442; and

an index construction module 464 for constructing a document index 462 from a set of documents 466.

The methods of the present invention begin before a vertical search query is received by query handler 420 with index construction module 464. Index construction module 464 constructs a document index 462 by scanning documents 466 for relevant search terms. An illustration of document index 462 is illustrated below:

| Term | Document Identifier |
|---|---|
| term 1 | docID₁ₐ, . . . , docID₁ₓ |
| term 2 | docID₂ₐ, . . . , docID₂ₓ |
| term 3 | docID₃ₐ, . . . , docID₃ₓ |
| . | |
| . | |
| . | |
| term N | docID_{Na}, . . . , docID_{Nx} |

In some embodiments, document index 462 is constructed by index construction module 464 using conventional indexing techniques. Exemplary indexing techniques are disclosed in United States Patent publication 20060031195, which is hereby incorporated herein by reference in its entirety. By way of illustration, in some embodiments, a given term may be associated with a particular document when the term appears more than a threshold number of times in the document. In some embodiments, a given term may be associated with a particular document when the term achieves more than a threshold score. Criteria that can be used to score a document relative to a candidate term include, but are not limited to, (i) a number of times the candidate term appears in an upper portion of the document, (ii) a normalized average position of the candidate term within the document, (iii) a number of characters in the candidate term, and (iv) a number of times the document is referenced by other documents. High scoring documents are associated with the term. Document index 462 stores the list of terms, a document identifier uniquely identifying each document associated with terms in the list of terms, and the scores of these documents. Those of skill in the art will appreciate that there are numerous methods for associating terms with documents in order to build document index 462 and all such methods can be used to construct document index 462 of the present invention.

There is no limit to the number of terms that may be present in document index 462. In some embodiments, all combinations of character strings between 1 and 10 ASCII characters in length are represented as terms in document index 462. In some embodiments all combinations of character strings between 1 and 20 ASCII characters in length are represented as terms in document index 462. In some embodiments, all combinations of character strings between 1 and 30 ASCII characters in length are represented as terms in document index 462. In still other embodiments, all combinations of character strings between 1 and 50 ASCII characters in length are represented as terms in document index 462. Moreover, there is no limit on the number of documents 466 that can be associated with each term in document index 462. For example, in some embodiments, between zero and 100 documents 466 are associated with a search term, between zero and 1000 documents 466 are associated with a search term, between zero and 10,000 documents 466 are associated with a search term, or more than 10,000 documents 466 are associated with a search term with document index 462. Moreover, there is no limit on the number of search terms to which a given document 466 can associate. For example, in some embodiments, a given document 466 is associated with between zero and 10 search terms, between zero and 100 search terms, between zero and 1000 search terms, between zero and 10,000 search terms, or more than 10,000 search terms.

In the context of this application, documents 466 are understood to be any type of media that can be indexed and retrieved by a search engine, including web documents, images, multimedia files, text documents, PDFs or other image formatted files, ringtones, full track media, and so forth. A document 466 may have one or more pages, partitions, segments or other components, as appropriate to its content and type. Equivalently a document 466 may be referred to as a “page,” as commonly used to refer to documents on the Internet. No limitation as to the scope of the invention is implied by the use of the generic term “documents.” In the present invention, there are many documents 466 indexed by index construction module 464. Typically, there are more than one hundred thousand documents, more than one million documents, more than one billion documents, or even more than one trillion documents indexed by index construction module 464.

Vertical collections 450 are constructed using documents in document index 462 that pertain to a particular non-hierarchical category. For example, one vertical collection 450 may be constructed from documents indexed by document index 462 that pertain to movies, another vertical collection 450 may be constructed from documents indexed by document index 462 that pertain to sports, and so forth. Vertical collections 450 can be constructed, merged, or split in a relatively straightforward manner by the vertical engine server system operator. In some embodiments, there are hundreds of vertical collections 450 set up in this manner. In some embodiments, there are thousands of vertical collections 450 set up in this manner.

Once document index 462 has been constructed by index construction module 464, it is possible for vertical index construction module 460 to construct vertical index 442. To accomplish this, each vertical collection 450 is inverted. Recall from FIG. 4, that each vertical collection 450 has the form:

Vertical collection (V₁)

DocId₁₋₁
DocId₁₋₂
.
.
.
DocId_{1-P}

In some embodiments, each DocId in the vertical collection 450 further includes a document quality score assigned by index construction module 464. Inversion of each of the vertical collections 450 and the merging of each of these inverted vertical collections leads to an inverted document-vertical index having the following data structure:

| Document | Associated vertical |
|---|---|
| identifiers | collections 450 |
| DocId₁₋₁ | Vₐ, . . . , Vₓ |
| DocId₁₋₂ | V_{b}, . . . , V_{y} |
| . | |
| . | |
| . | |
| DocId_{1-P} | V_{c}, . . . , V_{z} |
| DocId₂₋₁ | V_{d}, . . . , Vₐₐ |
| . | |
| . | |
| . | |

Thus, for each given document 466 in document index 462, a list of vertical collections 450 associated with the given document are provided in the inverted document-vertical index. There can be several vertical collections 450 associated with any given document. Further, there is no requirement that each document 466 be associated with a unique set of vertical collections 450.

With the inverted document-vertical index, it is now possible to create vertical index 442 by substituting the document identifiers in document index 462 with the corresponding vertical collections associated with such document identifiers as set forth in the inverted document-vertical index. In one approach, this is done by scanning document index 462 on a termwise basis, and collecting the set of vertical collections 450 that are associated with the documents that are, themselves, associated with each term as set forth in the inverted document-vertical index. For example, consider a term 1 in the exemplary document index 462 presented above. According to document index 462, term 1 is associated with docID₁ₐ, . . . , docID₁ₓ. Thus, for each respective docIDᵢ in the set docID₁ₐ, . . . , docID₁ₓ, the inverted document-vertical index is consulted to determine which vertical collections 450 are associated with the respective docIDᵢ. Each of these vertical collections 450 are then associated with term 1 in order to construct a vertical index list 444 for term 1. Thus, starting with the entry for term 1 in document index 462,

| | |
|---|---|
| term 1 | docID₁ₐ, . . . , docID₁ₓ |

the set of vertical collections associated with docID₁ₐ, . . . , docID₁ₓ are collected from the inverted document-vertical index in order to construct the vertical index list:

| | |
|---|---|
| term 1 | V₁, V₂, . . . , V_{N} |

where each of V₁, V₂, . . . , V_{N} is a vertical collection identifier that points to a unique vertical collection 450. This data structure is a vertical index list 444. As illustrated, a vertical index list 444 is a list of vertical collection identifiers of vertical collections 450 sharing a definable attribute (e.g., “term 1”). If term 1 was “vacation,” than vertical index list 444 contains the identifiers of the vertical collections 450 holding documents containing the word “vacation.” The predicate defining the list, “term 1” in the above example, is referred to as the “head term.”

By considering all the terms in a collection of terms, vertical index 442 is constructed. There may be a large number of terms in the collection of terms. For example, in some embodiments, the collection of terms contains all combinations of character strings between 1 and 10 ASCII characters in length, all combinations of character strings between between 1 and 20 ASCII characters in length, all combinations of character strings between 1 and 30 ASCII characters in length, or all combinations of character strings between between 1 and 50 ASCII characters in length. Vertical index 442 comprises vertical index lists 444, along with an efficient process for locating and returning the vertical index list 444 corresponding to a given attribute (search term). For example, a vertical index 442 can be defined containing vertical index lists 444 for all the words appearing in a collection. Vertical index 442 stores, for each given word in the collection, a vertical index list 444 of those vertical collections 450. Each such vertical collection 450 in the vertical index list 444 for the given word holds at least some documents 466 containing the given word.

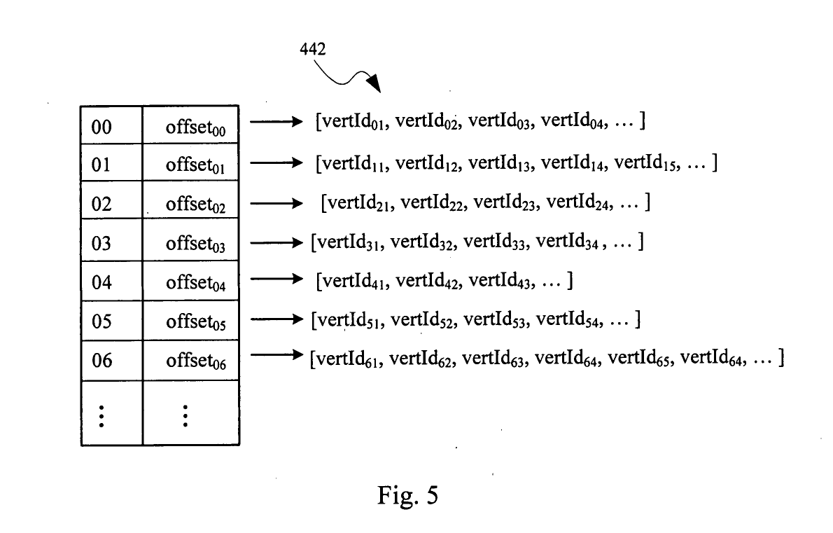

Referring to FIG. 5, a specific structure for vertical index 442 is provided in accordance with one embodiment of the present invention. In this embodiment, vertical index 442 comprises a hash lookup table and a vertical index list storage component. The hash lookup table contains pointers or file offsets that pinpoint the location of an individual vertical index list 444. A hash of a given head term (search term) provides the correct offset to corresponding list of vertical collections 450 that hold documents 466 for the given head term. For example, consider the case in which the head term is “vacation.” The head term is hashed to, in this example, give the offset 03. A table lookup at offset 03 in vertical index 442 gives the list of identifiers [vertId₃₁, vertId₃₂, vertId₃₃, vertId₃₄, . . . ] that correspond to the head term “vacation.” Each identifier in the set [vertId₃₁, vertId₃₂, vertId₃₃, vertId₃₄, . . . ] corresponds to a vertical collection 450 that contains documents with the “vacation” head term. Continuing to refer to FIG. 5, the vertical index lists 444 are shown as having different lengths because that is the usual case. In some embodiments, a term specific score is associated with each vertical identifier in each vertical index list 444 as described in more detail below.

Steps for constructing a vertical index 442 have been detailed above. The vertical index 442 includes, for each respective head term in a collection of head terms, the list of vertical collections 450 having documents that contain the respective head term. To optimize vertical index 442, additional steps are taken to rank each vertical collection 450 referenced in each respective vertical index list 444 so that only the most significant vertical collections 450 are returned for any given vertical search query. Thus, for each respective head term (t) represented in vertical index 442, each vertical collection (v) listed in the vertical index 444 for the respective head term is scored with the respect to the head term to give a score(t,v). The score for a vertical collection 450, given a specific head term score(t,v), can be computed many different ways. In some embodiments, the score for a vertical collection 450, given a specific head term (score(t,v)), is computed by summing over all documents 466 in the vertical collection as follows:

$$score ( t , v ) = [ {\sum }_{d ∈ V} score ( t , d ) ] \cdot w ( d , v ) \qquad ( I )$$

where score(t,d) is the score for a document in the vertical collection 450 and w(d,v) is some weight assigned to the vertical collection 450 that contains the document.

In some embodiments, w(d,v) is a weight that upweights those vertical collections 450 that have the highest frequency of the given head term. In other words, in such embodiments, w(d,v) is higher for a first vertical collection 450 that has documents with a higher incidence of head term (t) than a second vertical collection 450 that has documents with a lower incidence of head term (t). In some embodiments, w(d,v) is a weight that upweights those vertical collections 450 that have a high prevalence of the head term in the highest ranked documents within such vertical collections 450. In other words, in such embodiments, w(d,v) is higher for a first vertical collection 450 that has a higher incidence of head term (t) within high ranked documents 466 of the first vertical collection 450 than a second vertical collection 450 that has a lower incidence of head term (t) within high ranked documents 466 of the second vertical collection 450. Here, high ranked documents 466 refer to those documents that have received a high rank by index construction module 464. Methods by which index construction module 464 assigns a high rank to certain documents 466 are well known in the art. One criterion for ranking a document 466, is for example, to asses how many other documents reference the given document 466. The idea behind such a ranking scheme is that the more documents that reference the given document, the more interesting the given document must be. Several other criteria and methods for ranking documents are known to those of skill in the art and all such criteria and methods can be used to rank documents 466 in the present invention. Then, such the rankings of such documents 466 in document index 462 is used to assign a score(t,v) for the vertical collections 450 that contain such documents. Alternatively, in less preferred embodiments, documents 466 can be ranked within vertical collections independently of index construction module 464 using the same criteria and methods generally used to rank documents in the art. In some embodiments w(d,v) is not used to compute score(t,v). That is, in some embodiments, there is no w(d,v). In some embodiments, w(d,v) for a given vertical collection 450 is a function of the popularity of the vertical collection 450, an aggregation of the link density for documents 466 within the vertical collection 450, or any other criterion that is normally used to evaluate the quality of documents 466.

In some embodiments

$$score ( t , d ) = ( A + log ( f ( d , t ) ) ) \cdot log ( B + \frac{f ( N )}{v ( t )} ) \qquad ( II )$$

where f(d,t) is the number of times the head term (t) occurs in document (d) of vertical collection 450, and f(N) is a function of the number of vertical collections 450 accessible to vertical search engine 424 (whether such vertical collections are stored in memory 414 and/or accessible via network interface 410). In some embodiments f(N) is simply Mᵥ, the number of vertical collections 450 stored in memory 414 and/or available via Network interface 410). In some embodiments f(N) is log(Mᵥ) or some other function of Mᵥ such as the root of Mᵥ. In formula (II), v(t) is the number of vertical collections 450 containing head term (t). In practice, v(t) is the number of vertical collections 450 that are in the vertical index list 442 for head term (t). Also, in formula (II), A and B are both equal to 1 in some embodiments. In other embodiments, A and B are the same or different constant numbers. In some embodiments A is larger than B. In some embodiments A is smaller than B. In some embodiments A is equal to B. Other formulas for score(t,d) are possible. For example, in some embodiments,
score(t,d)=f(d,t). (III)
where f(d,t) is the number of times the head term (t) occurs in document (d) of vertical collection 450.

Substituting formula (II) into formula (I) and rearranging, in some embodiments:

$$score ( t , v ) = log ( B + \frac{f ( N )}{v ( t )} ) {\sum }_{d ∈ V} ( A + log ( f ( d , t ) ) ) \cdot w ( d , v ) \qquad ( IV )$$

for embodiments where a global w(d,v) is applied to each document in an entire vertical collection 450, and

$$score ( t , v ) = log ( B + \frac{f ( N )}{v ( t )} ) {\sum }_{d ∈ V} ( A + log ( f ( d , t ) ) ) \cdot w ( d , t ) \qquad ( V )$$

for embodiments where a w(d,t) is applied to each document based on the identity of term (t).

In some embodiments, score(t,v) as expressed in either formula (IV) or (V) is part of an overall score (scoreₒᵥ) for a vertical collection 450 given a term (t) having the form:
μ₁*score₁(t,v)+μ₂*score₂(t,v) (VI)
where, score₂ is either score(t,v) of formula (IV) and (V) and score₁(t,v) has the form:
score₁(t,v)=score for head term t in vertical v=(C+log(f(v,t)))*log(D+f(N)/v(t)) (VII)
where f(v,t) is the number of documents 466 in vertical collection (v) containing term (t), f(N) is a function of the number of vertical collections tracked by memory 414 (e.g., N, the number of vertical collections tracked by memory 414, log(N), root of N, etc.), v(t) is the number of vertical collections 450 in the vertical index list 444 of term (t), and C and D are constants. C and D are both equal to 1 in some embodiments. In other embodiments, C and D are the same or different constant numbers. In some embodiments C is larger than D. In some embodiments C is smaller than D. In formula (VI), μ₁ and μ₂ are terms that can be independently adjusted. In typical embodiments, μ₁ and μ₂ are constant values. These values can be the same or different. In some embodiments, μ₁ is zero. In some embodiments μ₁ is a constant value that is less than μ₂. In some embodiments, μ₁ is a constant value that is greater than μ₂.

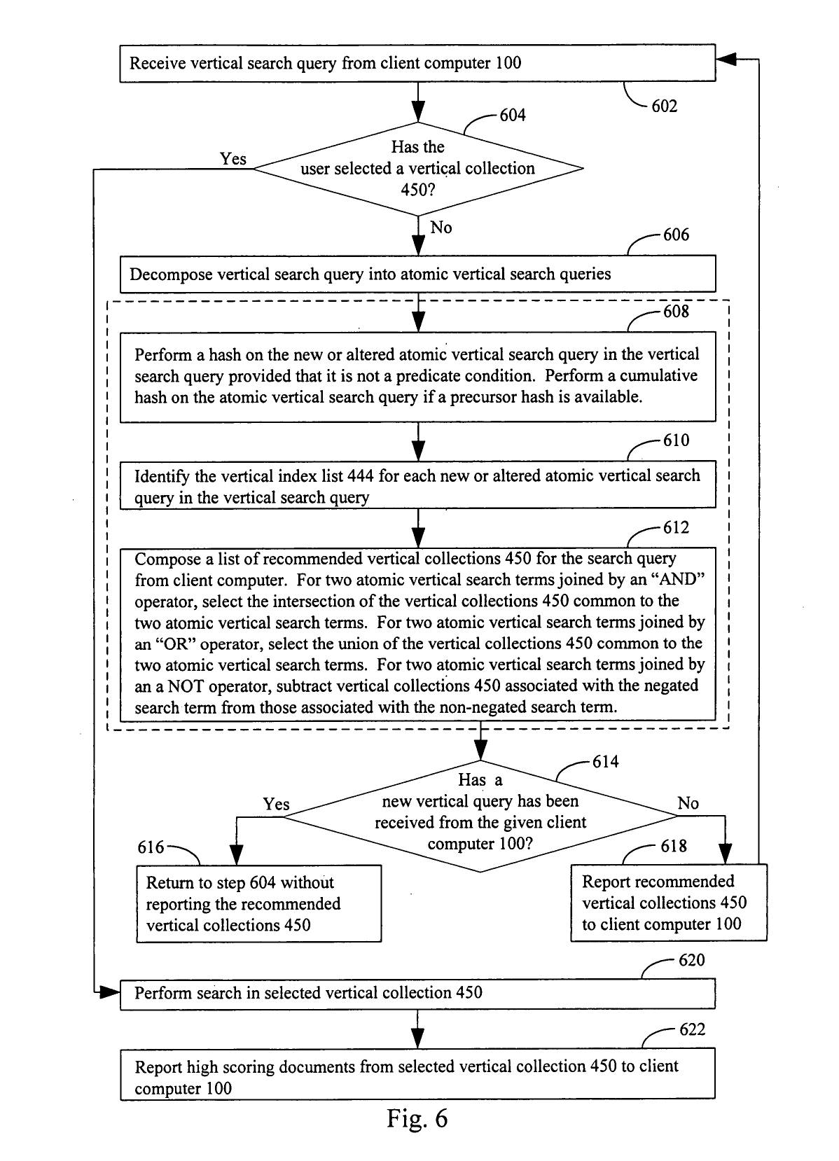

Referring to FIG. 6, an exemplary method in accordance with one embodiment of the present invention is described. The method details the steps taken by vertical search engine 424 to interactively provide a user with a recommended list of vertical collections 450 as the user builds a vertical search query.

Step 602. In step 602, a vertical search query is received from client computer 100. A vertical search query comprises a list of keywords, possibly joined by the Boolean operators AND, OR, as well as NOT, and optionally grouped with parentheses or quotes. Examples of vertical search queries include: (i) “Florida discount vacations,” (ii) “The President of the United States,” and “(car OR automobile) AND (transmission OR brakes).” Referring to FIG. 3, a vertical search query is the contents of prompt 302 at a given time point. In some embodiments, the vertical search query is in the form of an http request.

Step 604. In step 604, a determination is made as to whether a user has selected a vertical collection 450. Referring to FIG. 3A, a user can, for example, select a vertical collection 450 at any time by selecting any of the vertical collections listed in v-cloud 304. In some embodiments, no vertical collections 450 are listed in v-cloud 304 when prompt 302 is empty and thus, at the stage when prompt 302 is empty, the user cannot select a vertical collection 450 in such embodiments. In some embodiments, v-cloud 304 is populated with popular and/or sponsored vertical collections 450 when prompt 302 is empty. If a user has not selected a vertical category (604-No), then control passes to step 606. If a user has selected a vertical category (604-Yes), then control passes to step 620.

Step 606. In step 606, the vertical search query is decomposed into atomic vertical search queries. An atomic vertical search query consists of a single term or predicate condition. For example, the vertical search query “(car OR automobile) AND (transmission OR brakes)” includes the single terms “car”, “automobile”, “transmission”, “brakes” and the predicate conditions of precedence “( )”, AND, as well as OR.

Step 608. In typical embodiments, only one of the atomic vertical search queries in the vertical search query will be new or altered. Thus, in step 608, the atomic vertical search query that is new or has been altered is first identified. To illustrate, consider the case where the vertical search query in the last instance of step 608 was “car OR auto” whereas in the current instance of step 608, the vertical search query is “car OR automobile”. In step 606, the vertical search query “car OR automobile” is broken down to the atomic vertical search queries “car” and “automobile.” The atomic vertical search query “car” remains unchanged relative to the last instance of step 608 and therefore is not hashed in the new instance of step 608. The atomic vertical search query “automobile”, on the other hand, had the form “auto” in the last instance of step 608 and is therefore not hashed in the new instance of step 608. In some embodiments, rather than rehashing the full atomic vertical search “automobile” the hash of “auto” from the previous instance of step 608 is used and a cumulative hash is performed with the additional characters “mobile” in order to arrive at the full hash for “automobile” in the current instance of step 608. In some embodiments, such cumulative hashing is not performed. Cumulative hashing is preferable in some embodiments so that recommended verticals collections 450 can be returned to client computer 100 before the user has had a chance to enter many more keystrokes into prompt 302. Thus, any techniques that will speed up the computation of steps 606 through 612 are preferred.

In some embodiments atomic vertical search queries are not hashed. In such embodiments, vertical index 442 is not ordered by the hash values of atomic vertical search queries. In some embodiments, more than one atomic vertical search query within the vertical search query is new or has been altered. In such embodiments, each new or altered atomic vertical search query is separately hashed in step 608. If a precursor expression is available for any of these altered atomic vertical search queries, the hash of such precursor expressions is used to speed up the hash of the corresponding altered atomic vertical search query.

Step 610. In step 610, the vertical index list 444 for each new or altered atomic vertical search query in the vertical query is identified. In embodiments where vertical index 442 is a hash table, such as illustrated in FIG. 5, this operation is a simple hash lookup using the respective hash of each new or altered atomic vertical search query. In some embodiments, a hash is not used. For example, in some embodiments, vertical index 442 is some other form of data structure that contains vertical indices 444, such as an array, list, stack, queue, tree, or database. Such data structures are described in Brookshear, Computer Science, 2003, Addison-Wesley, New York, which is hereby incorporated by reference in its entirety. In some embodiments, the vertical indices 444 that correspond to atomic vertical search queries that are not new in the vertical search query are already known from previous instances of step 610 and are therefore not obtained in successive instances of step 610. In some embodiments, the vertical index 444 of each atomic vertical search query in the vertical search query is identified in each instance of step 610. Regardless of the embodiment, upon completion of step 610, the vertical index list 444 of each atomic vertical search query in the vertical search query is identified.

Step 612. In step 612, a list of recommended vertical collections 450 for the vertical search query from client computer 100 is composed. In the case where the vertical search query includes only one atomic vertical search term, step 612 simply involves extracting each of the names of the vertical collections 450 referenced in the vertical index 444 for the atomic vertical search term that was identified an instance of step 610. In the case where the vertical search term includes more than one atomic vertical search term, more work is required. Consider the case in which there are two atomic vertical search terms in a vertical search term query in which there is either no operator between the two search terms or the two search terms are joined by an “AND” operator. In this case, the names of the vertical collections 450 for each atomic vertical search term are first identified using the processes described above. So, if the atomic vertical search terms are term₁ and term₂, this operation results in the identification of the following:

| | |
|---|---|
| term₁ | VC₁₋₁, VC₁₋₂, . . . , VC_{1-N} |
| term₂ | VC₂₋₁, VC₂₋₂, . . . , VC_{2-M} |

Then, in order to identify a list of recommended vertical collections 450 in this instance, the intersection of each list of vertical collections 450 is taken in some embodiments of the present invention. This means that only those vertical collections 450 that are common to both vertical index lists 444 are included in the list of recommended vertical collections 450 in such embodiments. In some embodiments, in addition to the requirement that each recommended vertical collection be present in both index lists 444, each recommended vertical collection must have a minimum relevancy score(v,t).

Next consider the case in which two atomic vertical search terms are joined by an “OR” operator. Here, the union of the vertical collections 450 in the two vertical index lists 444 for the two search terms is taken. That is, vertical collections 450 that are in either vertical index list 444 are selected for inclusion in the list of names of candidate vertical collections 450 that are send back to client computer 100 in response to a vertical search query. In some embodiments the relevancy score for each vertical collection 450 in each vertical index list 444 is also used to determine which vertical collections 450 are selected for the list of names of candidate vertical collections 450. For example, in some embodiments, those vertical collections 450 that are represented in the vertical index list 444 of both atomic vertical search terms are summed. Because of this summing operation, there is a tendency for those vertical collections 450 that are represented in the vertical index list 444 of both atomic vertical search terms to appear in the list or recommended vertical collections 450 in such embodiments. However, it is still quite possible in such embodiments for vertical collections 450 that appear in only one of the two vertical index lists 444 to be recommended if such vertical collections 450 have a high score. The following example illustrates the point. Consider the vertical indexes 444 for term₁ and term₂ in which the quality or relevancy score of each vertical collection 450 has been computed and in which term₁ and term₂ are related by an “OR” operator:

| | |
|---|---|
| term₁ | VC₁₅₀(score_{150, t1}), VC₁₇₀(score_{170, t1}), VC₁₇₅(score_{175, t1}) |
| term₂ | VC₁₅₁(score_{151, t2}), VC₁₇₀(score_{170, t2}), VC₁₇₅(score_{175, t2}) |

Thus, for purposes of determining which vertical collections 450 are to be incorporated into the list of recommended vertical collections responsive to a given vertical search query, the following computations are made:
VC₁₅₀=score_{150,t1}
VC₁₇₀=score_{170,t1}+score_{170,t2}
VC₁₇₅=score_{175,t1}+Score_{175,t2}
VC₁₅₁=score_{151,t2}
Here, VC₁₇₀ and VC₁₇₅ benefit from the summation of two scores whereas VC₁₅₀ and VC₁₅₁ each receive only one score. However, it is still quite possible that VC₁₅₀ or VC₁₅₁ may have a higher score than VC₁₅₀ and VC₁₅₁ and therefore be included in the list of recommended vertical collections 450. Here, each of the scores may be any of the scores described with respect to formulas (I) through (VII) above, or some other score that assigns vertical collection quality or relevance of a vertical collection to a given search term.

For two atomic vertical search terms joined by a NOT operator, those vertical collections 450 in the vertical index list 444 of the negated search term are subtracted from the list of vertical collections 450 in the vertical index 444 associated with the non-negated search term to arrive at a recommended list of vertical collections for a given vertical search request. To illustrate, consider the vertical indexes 444 for term₁ and term₂ in which the quality or relevancy score of each vertical collection 450 has been computed and in which term₁ and term₂ are related by a “NOT” operator:

| | |
|---|---|
| term₁ | VC₁₅₀(score_{150, t1}), VC₁₇₀(score_{170, t1}), VC₁₇₅(score_{175, t1}) |
| term₂ | VC₁₅₁(score_{151, t2}), VC₁₇₀(score_{170, t2}), VC₁₇₅(score_{175, t2}) |

Thus, in this case, only the vertical collection VC₁₅₀ would be selected for inclusion in the list of recommended vertical collections 450.

More complex logical expressions can be built using combinations of atomic vertical search queries joined by Boolean expressions such as AND, OR as well as NOT. Moreover, precedence can be introduced using parentheses. Those of skill in the art will appreciate that other forms of logic can be used to merge or split lists of vertical collections 450 in vertical indexes 442 in order to arrive at a final set of list of recommended vertical collections for a given vertical search query and all such forms of logic are within the scope of the present invention.

In some embodiments, the list of recommended vertical collections 450 contains a maximum number of vertical collections 450. For some search expressions, the number of vertical collections 450 identified does not exceed this maximum. However, for some search expressions, the number of vertical collections 450 identified does exceed the maximum possible number of recommended vertical collections 450. In such embodiments, the term-based relevancy score associated with each vertical collection 450 is used to determine which vertical collections are included in the recommendation list of vertical collections for a given vertical search query. Only top scoring vertical collections 450 are selected for the list.

Steps 614-618. The lookup performed by steps 608 through 612 is designed to be fast. In some embodiments, a recommended list of vertical collections 450 is returned to client computer 100 between each character stroke entered by a user into prompt 302. Correspondingly, in some embodiments, client computer 100 sends a new vertical search query each time the user enters a new character into prompt 302 of FIG. 3. In some embodiments, client computer sends a new vertical search query each time an end of string signal is detected by client computer 100. Such an end of string signal is detected by client computer 100 in some embodiments when a pause in the typing of the user is detected. For example, referring to FIGS. 3A and 3B, if there is a delay (e.g., a 1 second, a 2 second delay, a 3 second delay, etc.) between entering the “t” (FIG. 3A) and the “i” (FIG. 3B), then the end of string signal is detected by client computer 100 and the “t” is sent to the remote server (vertical engine server 110) as a vertical search query. In some embodiments, an end of string signal is also detected when a space character or carriage return, or other designated character, is entered into prompt 302 by a user.

In some embodiments, a check is performed to determine whether a new vertical query has been received from client computer 100 (step 614). For example, in some embodiments, a determination is made as to whether a new http request has arrived from the client computer 100 with a new or revised vertical search query. If a new or revised vertical query has been received (614-Yes), control is passed back to step 604 without reporting the recommended vertical collection (step 616). If a new or revises vertical search query has not arrived (614-No), then the recommended vertical collections 450 are reported to client computer 100 where they are displayed in a graphic such as v-cloud 304 (step 618). In some embodiments, the recommended vertical collections 450 are reported to client computer 100 even when a new vertical search query has arrived from client computer 100.

In some embodiments, the list of recommended vertical collections that is returned to client computer 100 includes both the identity of the recommended vertical collections 450 (names) and a relevancy score for each vertical collection 450. Such relevancy scores are computed, for example using any of the scoring functions described with respect to formulas (I) through (VII) above, or any other scoring function that assesses vertical collection 450 quality and/or vertical collection 450 to a given vertical search query. Then, as illustrated in FIG. 3, those vertical collections that have higher scores are displayed as larger graphics than those vertical collections that have smaller relevancy scores. For example, referring to FIG. 3, for the vertical search query “t”, the vertical collection “Apparel” has a higher overall relevancy score than the vertical collection “television programs.” Thus, the vertical collection “Apparel” is displayed as a larger graphic than the vertical collection “television programs” in v-cloud 304. In some embodiments, rather than, or in addition to displaying vertical collections 450 having a greater degree of relevance as larger graphics, other indicia can be used. For example, such vertical collections can be listed in colors selected from a color spectrum. For instance, more relevant vertical collections would be at one end of the color spectrum, say green, while less relevant vertical collections would be at the other end of the color spectrum. Also, more relevant vertical collections can be displayed in a bolder format, while less relevant vertical collections can be displayed in a less bold format.

Upon completion of step 618, control passes back to step 602 in order to wait for a new vertical search query.

Steps 620-622. Eventually, the user selects a vertical collection 450. When this occurs, the vertical search query is directed to the selected vertical collection 450. The selected vertical collection 450 is searched for those documents that are most relevant to the final vertical search query (step 620). In some embodiments, search engine 422 performs the search of the selected vertical collection 450. Then, in step 622, these high ranking documents are reported to client computer 100 where they are displayed, for example, as shown in FIG. 3F.

Computer systems, graphical user interfaces, computer program products, and methods have been disclosed for automatically recommending vertical collections to a user who is constructing a search query. The techniques are highly advantageous for several reasons. The search of vertical index 442 is extremely fast. This enables vertical search engine 424 to return a list of recommended vertical collections 450 to the user between user keystroke. Thus, the user can quickly see what kinds of topics are relevant to the search query and can either select one of the categories, continue to type in a search query, or in the case where uninteresting vertical collections 450 are emerging, start fresh with a new vertical search query. With the present invention, the user can enjoy all the benefits of performing searches within a relevant vertical collection without having to navigate through hierarchical lists of categories or make a uniformed guess as to what might be the correct category to search. Moreover, from a server perspective, the invention is highly advantageous because, as illustrated in FIG. 3F, the user-based selection of a vertical collection provides, coupled with the vertical search query, provides a basis for removing any ambiguity in the search query (e.g., determine whether tiger means “Tiger Woods”, the Macintosh operating system, or animals) and therefore deliver meaningful and relevant advertisements and/or sponsored links.

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a computer readable storage medium. For instance, the computer program product could contain the program modules shown in FIG. 4. These program modules can be stored on a CD-ROM, DVD, magnetic disk storage product, or any other computer readable data or program storage product. The software modules in the computer program product may also be distributed electronically, via the Internet or otherwise, by transmission of a computer data signal (in which the software modules are embedded) on a carrier wave.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed:

1. A graphical user interface stored in a memory of a client computer, the graphical user interface comprising:
a prompt field for obtaining a vertical search query from a user; and
a display field for displaying a plurality of names, wherein each name in the plurality of names represents a vertical collection in a plurality of vertical collections; wherein
the plurality of names in said display field is automatically populated, at a time when the user is still typing additional characters in the prompt field, as a function of the vertical search query.

2. The graphical user interface of claim 1, wherein each respective name in said plurality of names in said display field is displayed as a graphic having a size that is a function of a relevance of the vertical collection that is represented by said respective name.

3. The graphical user interface of claim 2, wherein a first graphic in the display field has a larger size then a second graphic in the display field when the first graphic represents a first vertical collection in the plurality of vertical collections that is more relevant to the vertical search query than a second vertical collection in the plurality of vertical collections that is represented by said second graphic.

4. The graphical user interface of claim 1, wherein each name in said plurality of names in said display field is displayed as a graphic having a visual indicia, and wherein the visual indicia of a respective graphic displayed in the display field is determined by a vertical search query based relevance of the vertical collection represented by said respective graphic.

5. The graphical user interface of claim 4, wherein the visual indicia is size or color.

6. The graphical user interface of claim 1, wherein each vertical collection in the plurality of vertical collections is located on a remote server and comprises documents that relate to a particular category.

7. The graphical user interface of claim 1, wherein said graphical user interface is run as an application within a network accessible browser.

8. The graphical user interface of claim 1, wherein the plurality of names in said display field is re-populated each time one or more characters is entered by said user in said prompt field by communicating the contents of said prompt field to a remote server after one or more characters is entered by said user and receiving a new plurality of names from said remote server to display in said display field as a function of the contents of said prompt field.

9. The graphical user interface of claim 8, wherein the contents of said prompt field are sent to a remote server after each character is typed into said prompt field by a user.

10. The graphical user interface of claim 8, wherein the contents of said prompt field are sent to a remote server when an end of string signal is detected.

11. The graphical user interface of claim 1, wherein the vertical search query comprises a single character.

12. The graphical user interface of claim 1, wherein the vertical search query comprises a plurality of terms, wherein terms in the plurality of terms are optionally separated from each other by one or more predicate conditions.

13. A computer program product for use in conjunction with a client computer system, wherein the computer program product comprises a computer readable storage medium and a computer program mechanism embedded therein, the computer program mechanism comprising instructions for:
receiving a vertical search query from a user of said client computer system;
communicating said vertical search query to a remote computer;
receiving a plurality of names from said remote computer, wherein each name in the plurality of names represents a vertical collection in a plurality of vertical collections, and wherein each vertical collection in the plurality of vertical collections has a relevance to said vertical search query; and
displaying said plurality of names at a time when the user is still entering additional characters into said vertical search query.

14. The computer program product of claim 13, wherein each respective name in said plurality of names is displayed as a graphic having a size that is a function of a vertical search query based relevance of the vertical collection represented by said respective name.

15. The computer program product of claim 14, wherein a first graphic that is displayed has a larger size than a second graphic that is displayed when the first graphic represents a first vertical collection in the plurality of vertical collections that is more relevant to the vertical search query than a second vertical collection in the plurality of vertical collections that is represented by said second graphic.

16. The computer program product of claim 13, wherein each name in said plurality of names is displayed as a graphic having a visual indicia, and wherein the visual indicia of a respective graphic is determined by a vertical search query based relevance of the vertical collection represented by said respective graphic.

17. The computer program product of claim 16, wherein said visual indicia is size or color.

18. The computer program product of claim 13, wherein
the instructions for receiving further comprise instructions for receiving a vertical search query relevance score for each name in said plurality of names; and
the instructions for displaying further comprise instructions for displaying each name in the plurality names as a function of the relevance score for the name.

19. The computer program product of claim 13, wherein each vertical collection in said plurality of vertical collections is located on said remote server and comprises documents that relate to a particular category.

20. The computer program product of claim 13, wherein
the instructions for communicating said vertical search query are repeated each time one or more characters is entered by said user into said vertical search query; and
a plurality of names is received from said remote computer, by said instructions for receiving a plurality of names, all or a portion of the times said instructions for communicating are repeated; and
the instructions for displaying are repeated each time a plurality of names is received by said instructions for receiving a plurality of names; wherein each plurality of names represents vertical collections has a relevance to a corresponding vertical search query communicated by said instructions for communicating.

21. The computer program product of claim 20, wherein the instructions for communicating a vertical search query are repeated each time a single character is entered by said user into said vertical search query.

22. The computer program product of claim 20, wherein the instructions for communicating said vertical search query are repeated each time an end of string signal is detected.

23. The computer program product of claim 13, wherein the vertical search query comprises a single character.

24. The computer program product of claim 13, wherein the vertical search query comprises a plurality of terms, wherein terms in the plurality of terms are optionally separated from each other by one or more predicate conditions.

25. A computer comprising:
a central processing unit;
a memory coupled to the central processing unit, the memory storing instructions for:
receiving a vertical search query from a user of said computer;
communicating said vertical search query to a remote computer;
receiving a plurality of names from said remote computer, wherein each name in the plurality of names represents a vertical collection in a plurality of vertical collections, and wherein each vertical collection in the plurality of vertical collections has a relevance to said vertical search query; and
displaying said plurality of names at a time when the user is still entering additional characters into said vertical search query.

26. A digital signal embodied on a carrier wave, comprising:
a plurality of names, wherein each name in the plurality of names represents a vertical collection in a plurality of vertical collections, and wherein each vertical collection in the plurality of vertical collections has a relevance to a vertical search query; and
a plurality of scores, wherein each score in the plurality of scores corresponds to a name in the plurality of names, and wherein each score represents a relevance of a vertical collection in the plurality of vertical collections to said vertical search query.

27. The digital signal of claim 26, wherein the vertical search query comprises a single character.

28. The digital signal of claim 26, wherein the vertical search query comprises a plurality of terms, wherein terms in the plurality of terms are optionally separated from each other by one or more predicate conditions.
